(19) United States
(12) Patent Application Publication
(10) Pub. No.: US 2008/0173504 A1
(43) Pub. Date: Jul. 24, 2008

(54) Device for Brake Application in a Motor Vehicle

(75) Inventors: Peter Drott, Frankfurt/M (DE); Michael Vogt, Simmern (DE); Stephan Krebs, Eschborn (DE)

Correspondence Address: RATNERPRESTIA, P O BOX 980, VALLEY FORGE, PA, 19482-0980, US

(73) Assignee: Continental Teves AG & Co. oHG, Frankfurt (DE)

(21) Appl. No.: 11/911,578

(22) PCT Filed: Apr. 11, 2006
(86) PCT No.: PCT/EP06/61514

§ 371 Date: Oct. 15, 2007

(30) Foreign Application Priority Data
Apr. 15, 2005 (DE) 10 2005 017 706.9
Apr. 3, 2006 (DE) 10 2006 015 850.4

(51) Int. Cl. B60T 11/10

(52) U.S. Cl. 188/152

(57) ABSTRACT

A device for the brake application of a motor vehicle comprising a master cylinder and a pneumatic brake booster, with one of the pistons of the master cylinder having a stepped design with two differently sized hydraulically active effective surfaces, and change-over of the effective surfaces takes place by means of a valve assembly upon failure of the brake booster. An annular chamber, delimited by the stepped piston and the housing, is connectable by means of the valve assembly either to the pressure chamber associated with the stepped piston or to a pressure fluid reservoir. The valve assembly comprises a first and a second valve, which are switchable depending on the pressure of the working chamber of the brake booster. The first valve in its activated position connects the pressure chamber to the annular chamber, and the second valve in its activated position closes the connection between the annular chamber and the pressure fluid reservoir.

This application is the U.S. national phase application of PCT International Application No. PCT/EP2006/061514, filed Apr. 11, 2006, which claims priority to German Patent Application No. DE102005017706.9, filed Apr. 15, 2005 and German Patent Application No. DE102006015850.4, filed Apr. 3, 2006, the contents of such applications being incorporated by reference herein.

### BACKGROUND OF THE INVENTION

1. Field of the Invention

The present invention relates to a device for the brake application of a motor vehicle comprising a master cylinder with a housing and a first and a second piston displaceably arranged in the housing, said piston delimiting together with the housing in each case a first and a second pressure chamber, which pressure chambers are connectable to an unpressurized pressure fluid reservoir by way of a pressure fluid channel and to wheel brakes by way of an outlet, and a pneumatic brake booster with a booster housing, whose interior is subdivided by at least one movable wall into at least one vacuum chamber and at least one working chamber, with the movable wall, depending on a pedal force effective on a piston rod, transmitting a force onto a push rod that can be connected to the first piston of the master cylinder, when the movable wall is subjected to the effect of a difference in pressure that prevails between the two chambers, with one of the pistons of the master cylinder having a stepped design with two differently sized hydraulically active effective surfaces and change-over of the effective surfaces takes place by means of a valve assembly upon failure of the brake booster.

2. Description of the Related Art

DE 197 56 248 A1, for example, discloses a device of this type for brake application. The master cylinder of this device includes a pressure chamber and an intermediate pressure chamber, which are connected to wheel brakes when the brake booster is functioning. Furthermore, there is provision of a device comprising a valve, which connects the pressure chamber to a supply chamber depending on a pressure in the vacuum chamber. Change-over of the master cylinder to a small effective surface renders it possible that the braking deceleration mandated by law, implying e.g. 0.3 g in Germany, can be complied with upon failure of the brake booster. With the brake booster functioning, a large effective surface ensures a conventional pedal feel, since a large pressure fluid volume can be displaced by way of the large effective surface, allowing a quick pressure buildup in brake circuits of the vehicle.

Especially in vehicles suited for everyday and in off-road vehicles, it becomes more and more difficult to find an acceptable compromise between the function of vacuum failure of the brake booster and a conventional pedal feel.

Besides, electronic brake systems are known in the art, which connect a hydraulic unit for the assistance of the driver of the motor vehicle when vacuum failure is detected. However, these systems are very cost-intensive.

An object of the invention is to provide another generic device, which allows achieving an acceptable compromise between the function of brake booster failure and a conventional pedal feel.

Another objective of the invention is directed to allowing a pressure increase in the brake circuits, when the brake booster has reached its operating point and additional pressure increase is necessary (overboost function), or when the vacuum available is insufficient in a cold start of the vehicle.

### SUMMARY OF THE INVENTION

According to the invention, these objects are achieved in that an annular chamber, which is delimited by the stepped piston and the housing, is connectable by means of the valve assembly either to the pressure chamber associated with the stepped piston or to a pressure fluid reservoir, in that the valve assembly comprises a first and a second valve, which are switchable depending on the pressure of the working chamber of the brake booster, and in that the first valve in its activated position connects the pressure chamber to the annular chamber and the second valve in its activated position closes the connection between the annular chamber and the pressure fluid reservoir. During normal operation of the brake booster, a short pedal travel can be realized, because a large pressure fluid volume is displaced due to the large effective surface of the stepped piston. Upon failure of the brake booster, the small effective surface of the stepped piston is important and allows a high pressure in the brake circuit even when low pedal forces are applied to the brake pedal. Switching the valve assembly depending on the pressure in the working chamber of the brake booster allows realizing two additional functions (overboost function and cold start function) without the need to take additional measures or the need for additional component parts.

According to a favorable embodiment, a simple design of the valve assembly can be achieved in that the first valve is connected through a first pressure fluid line to the pressure chamber and through a second pressure fluid line to the annular chamber, and in that a third pressure fluid line is provided, by way of which the annular chamber is connectable to the pressure fluid reservoir, with the second valve being arranged in the third pressure fluid line and the said line branching from the second pressure fluid line.

Preferably, a vacuum box is used to drive the valves of the valve assembly. Thus, the valves can be switched mechanically and do not depend on an energy supply of the vehicle.

A pre-assembly unit is achieved in that the valve assembly and the vacuum box are integrated in a change-over unit, with the result that the assembly of the device can be simplified to a major degree.

Preferably, the change-over unit can be secured to the master cylinder. This obviates the need for separate connecting lines between master cylinder and change-over unit.

According to another advantageous embodiment of the invention, however, it is likewise feasible that the change-over unit can be fastened as a separate component in the engine compartment. The attachment of the change-over unit can thereby be provided depending on the space available in the engine compartment irrespective of the brake booster/master cylinder unit.

An embodiment of the change-over unit that is optimized in terms of mounting space can be achieved in that the valves in the change-over unit are positioned on top of one another. To this end, the change-over unit preferably includes a first and a second housing portion, with the vacuum box being integrated in the first housing portion and the valves of the valve assembly being arranged in the second housing portion, and the vacuum box includes a spring-preloaded diaphragm subdividing the first housing portion into an atmospheric chamber and a vacuum chamber.

According to a favorable embodiment of the invention, the diaphragm is compressed in a wall of the first housing portion and in a piston, the valve assembly includes a first actuating tappet for the second valve, being positively engaged with the piston of the vacuum box, and a second actuating tappet of the first valve that is connected downstream in the flux of forces, and a valve member of the second valve is attached to the first actuating tappet and a projection of the second valve tappet forms the valve member of the first valve, and valve seats of the valves are arranged in recesses of the second housing portion.

According to other favorable embodiments, the master cylinder of the device can be designed as a central-valve tandem master cylinder or as a plunger-type construction.

A method of the invention for changing the effective surfaces of a device for brake application provides that the effective surfaces are changed over depending on the pressure of the working chamber of the brake booster.

According to an advantageous improvement of the method of the invention, the valve assembly is switched by means of a vacuum box.

### BRIEF DESCRIPTION OF THE DRAWINGS

Hereinbelow, the invention will be explained by making reference to the accompanying drawings, which show embodiments. In a highly schematic view in the drawings:

FIG. 1 shows a longitudinal cross-sectional view of a first embodiment of a device for brake application according to the invention;

FIG. 1a is an enlarged view of the master cylinder according to FIG. 1;

FIG. 1b is an enlarged cross-sectional view of the brake booster of FIG. 1;

FIG. 2 is a force-pressure diagram of the device of the invention according to FIG. 1;

FIG. 3 shows a change-over unit of the device for brake application of the invention according to FIG. 1 in the activated position;

FIG. 4 shows the change-over unit of the device for brake application of the invention according to FIG. 1 in the non-activated position;

FIG. 5 is a spatial view of the device for brake application of the invention according to FIGS. 1 to 4, and;

FIG. 6 is a longitudinal cross-sectional view of a master cylinder of a second embodiment of the device for brake application of the invention.

### DETAILED DESCRIPTION

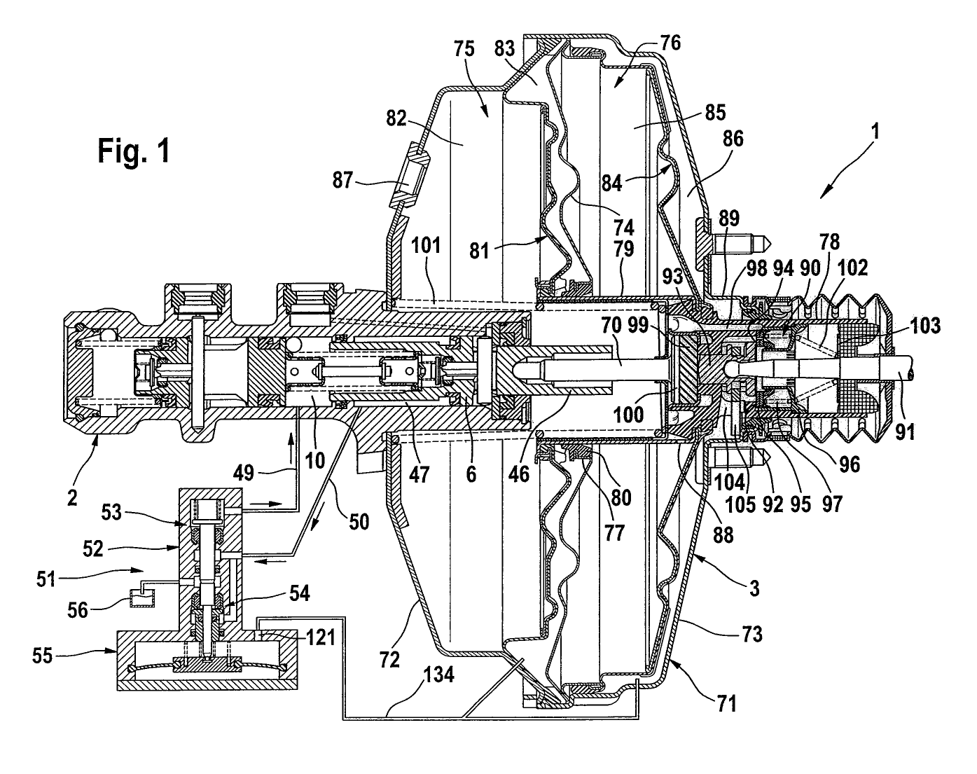

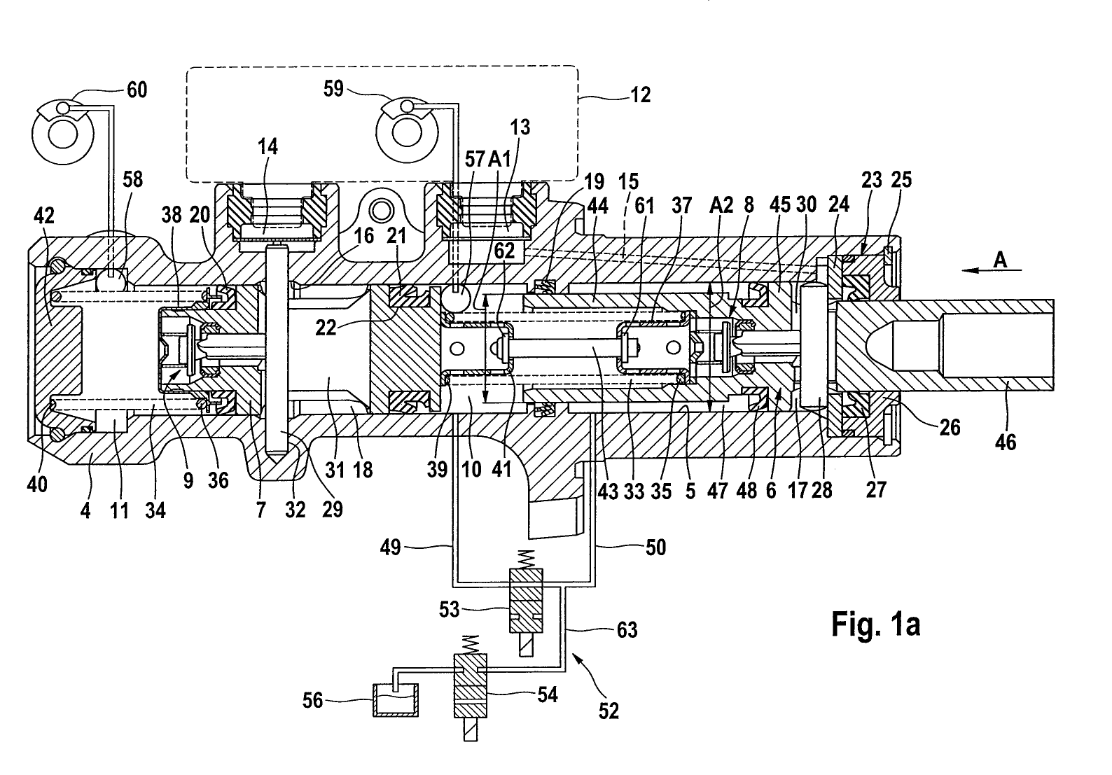

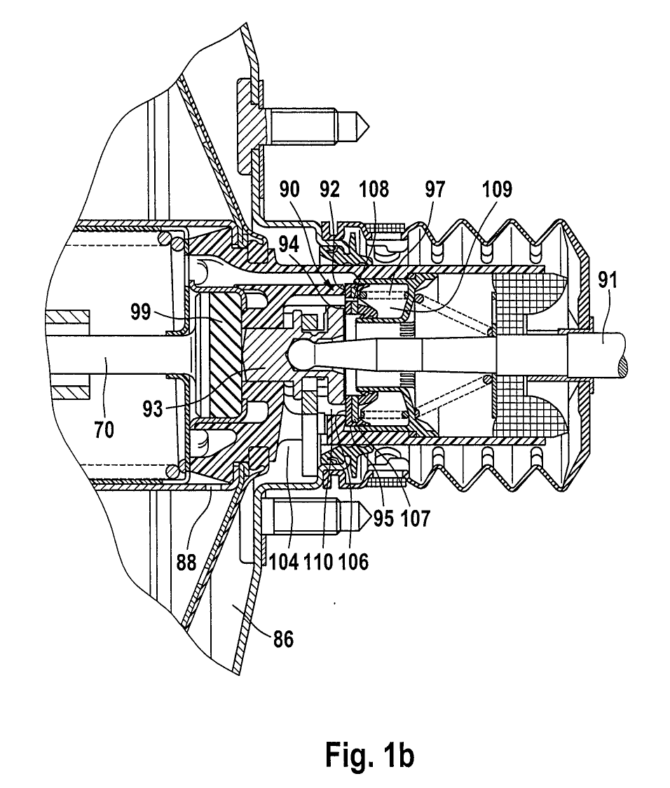

FIG. 1 is a longitudinal cross-sectional view of a first embodiment of a device for brake application according to the invention, which comprises a master cylinder 2 and a pneumatic brake booster 3.

The master cylinder 2, which is configured as a central-valve tandem master cylinder, is illustrated in an enlarged view in FIG. 1a. Said cylinder includes in its basic design a housing 4 with a longitudinal bore 5 for a first piston (push rod piston) 6 and a second piston (floating piston) 7. Further, there is provision of one central valve 8, 9 for each piston 6, 7. The respective central valve 8, 9 interacts for sealing an associated pressure chamber 10, 11 with the respective piston 6, 7 in consideration of a predetermined closure travel.

From an outlined unpressurized pressure fluid reservoir 12, pressure fluid channels 15, 16 open by way of connections 13, 14 into respective supply chambers 17, 18, which are sealed in relation to the associated pressure chambers 10, 11 by means of primary sealing cups 19, 20. Further, the supply chamber 18 is sealed by means of a secondary sealing cup 21 in relation to the first pressure chamber 10, and the secondary sealing cup 21 is arranged in a circumferential groove 22 of the second piston 7.

A sealing assembly 23 arranged in the housing 4 seals the supply chamber 17 relative to the brake booster 3. A plate 24 limits the sealing assembly 23 on the side facing the pressure chamber 10, and a safety element 25 secures the sealing assembly 23 and the plate 24 in the housing 4.

The sealing assembly 23 has a guide ring 26, which is made of a plastic material and serves as a low-wear guide of the first piston 6, and a secondary sealing cup 27 arranged on the guide ring 26 in the direction of the first pressure chamber 10.

In a non-activated condition, the central valves 8, 9 are kept open by stops 28, 29 designed as cylindrical pins, with the stops 28, 29 extending through slit-shaped recesses 30, 31 of the pistons 6, 7. The stop 28 is arranged in the longitudinal bore 5, and it abuts on the plate 24. On the other hand, the stop 29 is fixed in a housing bore 32 of the housing 4, and the slit-shaped recess 31 of the second piston 7 is arranged in an area between the primary sealing cup 20 and the secondary sealing cup 21.

Associated with each of the pistons 6, 7 is a resetting spring 33, 34, which is supported with a first end 35, 36 on a first sleeve 37, 38 and with a second end 39, 40 on a second sleeve 41 or on a housing cover 42, respectively. The first sleeve 37, 38 of the resetting spring 33, 34 is supported on the piston 6, 7. As is apparent from FIG. 1a, the resetting spring 33 is captivated by means of the two sleeves 37, 41 and a cylindrical pin 43. The two sleeves 37, 41 and the pin 43 can be telescoped within limits by means of stops 61, 62 designed on the pin 43 and elastically preload the resetting spring 33 in the non-activated condition.

Upon piston displacement in a direction of activation A, the resetting spring 33, 34 is compressed, while it is expanded for piston resetting purposes.

The first piston 6 has a stepped design and includes a first piston portion 44 with a first, small, hydraulically active effective surface A1 that faces the first pressure chamber 10, a second, middle piston portion 45 with a second, large, hydraulically active effective surface A2, and a third piston portion 46. The third piston portion 46 serves to connect the first piston 6 to a push rod 70 of the brake booster 3, as can be seen in FIG. 1.

Along with a housing 4, the first and the second piston portions 44, 45 delimit an annular chamber 47, which is sealed by means of another sealing cup 48 in relation to the supply chamber 17. Fluid can flow over the sealing cup 48 in the direction of the annular chamber 47.

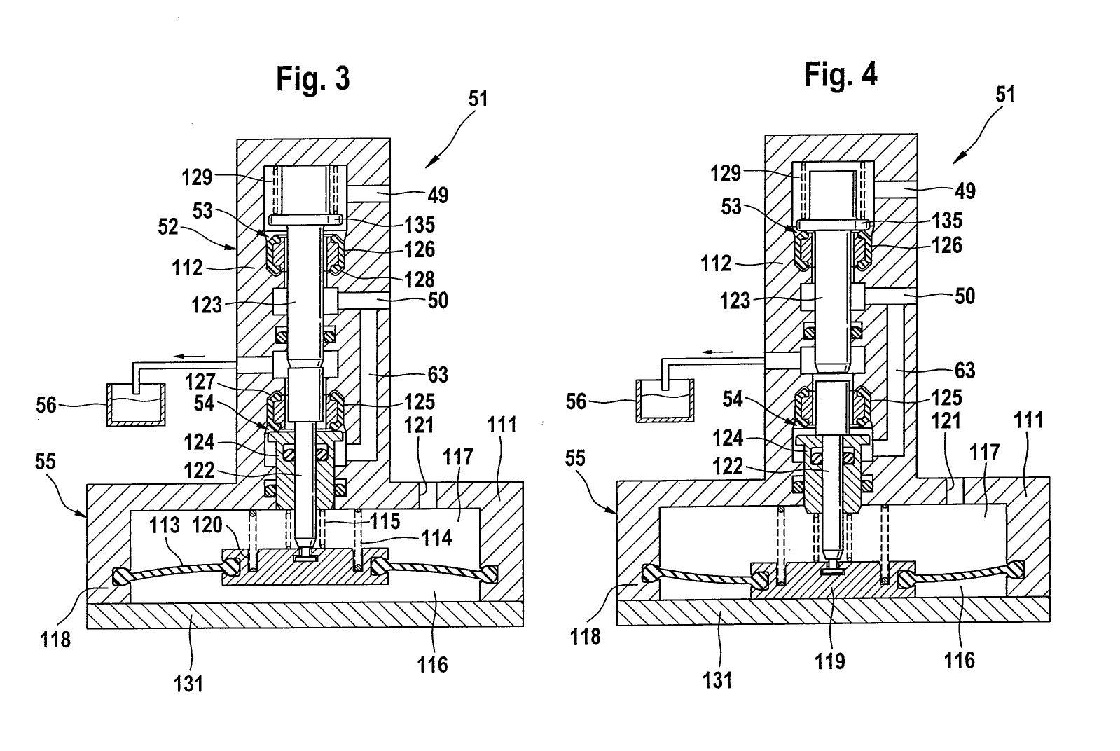

Further, it can be seen in FIG. 1 that the first pressure chamber 10 and the annular chamber 47 are connected to a change-over unit 51 by way of a first and a second pressure fluid line 49, 50. FIGS. 3 and 4 depict an enlarged view of the change-over unit 51, and the design and function thereof are explained in more detail in the following. Said unit comprises a valve assembly 52 with a first and a second mechanically operable valve 53, 54 and a vacuum box 55.

The annular chamber 47 is connectable either to the first pressure chamber 10 or to a separate pressure fluid reservoir 56 by means of the valve assembly 52, which can be operated depending on the pressure of one or two working chambers 83, 86 of the brake booster 3. It is likewise feasible within the limits of the invention that the annular chamber 47 can also be connected to the pressure fluid reservoir 12, thereby obviating the need for the separate pressure fluid reservoir 56.

In this arrangement, the first valve 53 in its activated position connects the pressure chamber 10 to the annular chamber 47, while the second valve 54 in its activated position closes the connection between the annular chamber 47 and the pressure fluid reservoir 56.

The mode of functioning of the central-valve tandem master cylinder 2 is principally known in the art. The first piston 6 is displaced to the left in the direction of activation A by way of the push rod 70 of the brake booster 3 when a brake pedal (not shown) is applied. This linear movement of the first piston 6 causes the associated central valve 8 to close, which is kept open by the stop 28 in the non-activated position illustrated, so that the corresponding pressure chamber 10 is shut off in relation to its connection 13 through the pressure fluid channel 15 and the supply chamber 17 to the pressure fluid reservoir 12. In consequence of the hydrostatic pressure developing in the pressure chamber 10, the second piston 7 is moved synchronously with the first piston 6 in the direction of activation A and closes its central valve 9 in the associated brake circuit. Hydraulic pressure will now equally develop in this brake circuit because the pressure chamber 11 is herein closed in relation to its connection 14 through the supply channel 16 and the supply chamber 18 to the pressure fluid reservoir 12. Consequently, practically the same hydraulic pressure prevails in both pressure chambers 10, 11 and is transmitted to wheel brakes 59, 60 through outlets 57, 58.

The pneumatic brake booster 3 shown in FIG. 1 and FIG. 1b is designed as a tandem-type brake booster and comprises a booster housing 71 including two shell-shaped booster housing halves or housing shells 72, 73 being preferably press fitted to each other by means of non-cutting shaping provisions. It is not compulsory to provide the brake booster 3 in a tandem design, it can also be designed as a single device.

The interior of the booster housing 71 is subdivided by means of a roughly centrically arranged, stationary partition 74 into a front booster chamber 75 close to the master cylinder and a rear booster chamber 76 close to the brake pedal. The partition 74 includes a centrically arranged circular recess 77, which is penetrated by a control housing 78 or rather its cylindrical extension 79, and the partition 74 is in sealing abutment on the extension 79 by means of a sealing element 80.

The front booster chamber 75 is subdivided by a first movable wall 81 into a first vacuum chamber 82 of constant pressure and into a first working chamber 83 of variable pressure, while a second movable wall 84 subdivides the rear booster chamber 76 into a second vacuum chamber 85 and a second working chamber 86. Usually, the front housing shell 72 is provided with a vacuum connection 87, by means of which the first vacuum chamber 82 can be connected to an appropriate vacuum source, e.g. a suction manifold of the motor vehicle engine, or to a vacuum pump. The connection of the two vacuum chambers 82, 85 occurs through recesses 88 in the cylindrical extension 79 of the control housing 78.

The rear housing shell 73 is provided with an axial portion 89 of small diameter in which the control housing 78 is guided in an axially movable and sealed manner. Housed in the interior of the control housing 78 is a control valve 90, allowing a controlled ventilation of the two working chambers 83, 86, and thereby controlling the difference in pressure between the vacuum chambers 82, 85 and the working chambers 83, 86.

The control valve 90 is operable by a piston rod 91 and comprises a first sealing seat 92 designed on the control housing 78, a second sealing seat 941 that is designed on a valve piston 93 connected to the piston rod 91, and a valve member 95, which cooperates with both sealing seats 92, 94 and is urged against the sealing seats 92, 94 by means of a valve spring 97 being supported on a guide element 94. The second working chamber 86 can be connected to the first vacuum chamber 82 by way of a duct 98 that extends laterally in the control housing 78. The piston rod 91 connects to a brake pedal (not shown).

By way of a rubber-elastic reaction disc 99 that abuts frontally on the control housing 78 and the push rod 70 having a head flange 100, brake force is transmitted to the first piston 6 of the master cylinder 2 of the brake system, which is mounted at the vacuum-side end of the brake booster 3, i.e. at the front housing shell 72. The input force introduced at the piston rod 91 is transmitted to the reaction disc 99 by means of the valve piston 93.

A represented resetting spring 101, which is supported on the vacuum-side end wall of the booster housing 71, maintains the movable walls 81, 84 in the initial position shown. In addition, a return spring 102 is provided, which is arranged between a holding element 103 arranged at the piston rod 91 and the guide element 96, and the force of which produces a bias of the valve piston 93 or its valve seat 94 relative to the valve member 95.

In order to connect the second working chamber 86 to the atmosphere when the control valve 90 is operated, a roughly radially extending channel 104 is designed in the control housing 78. The return movement of the valve piston 93 at the end of a brake operation is delimited by a transverse member 105, which bears against the booster housing 71 in the release position of the brake booster 3 as shown in the drawing.

As can be taken in particular from the enlarged cross-sectional view of the brake booster 3 illustrated in FIG. 1b, the valve member 95 includes an annular sealing surface 106, which cooperates with the two sealing seats 92, 94, which is reinforced by a metallic reinforcing disc 107 and includes several axial passages 108.

A pneumatic chamber 109 is delimited in the control housing 78. The flow ducts (not referred to in detail) being provided by the passages 108 connect the pneumatic chamber 109 to an annular chamber 110 that is delimited by the sealing seats 92, 94 and into which the above-mentioned pneumatic channel 104 opens so that the pneumatic chamber 109, which is arranged on the side of the valve member 95 remote from the sealing surface 106, is in constant communication with the second working chamber 86, and pressure balance takes place at the valve member 95.

As is generally known, vacuum prevails in the working chambers 83, 86 in the illustrated release position of the brake booster 3 and in a partial braking position. Thus, the valves 53, 54 of the valve assembly 52 remain activated because sufficient vacuum is available to the brake booster 3. The annular chamber 47 is in communication with the pressure chamber 10 via the pressure fluid lines 49, 50 and the valve 53, whereby the large effective surface A2 of the first piston 6 is hydraulically active. This surface provides a conventional pedal feel, since a large pressure fluid volume can be displaced, allowing a quick pressure buildup in brake circuits of the vehicle. The second valve 54, which is arranged in another, a third pressure fluid line 63, closes in the activated position the connection between the annular chamber 47 and the pressure fluid reservoir 56. As can be seen in FIG. 1a in particular, which shows only the valves 53, 54 as hydraulic wiring diagrams, the pressure fluid line 63 branches from the pressure fluid line 50.

The change-over unit 51 enables change-over of the master cylinder 2 from the large effective surface A2 to the small effective surface A1 when no vacuum or insufficient vacuum is available in the working chambers 83, 86 upon failure of the brake booster 3.

Since the operation of the valve assembly 52 is carried out depending on the pressure in the working chambers 83, 86, change-over to the small effective surface A1 can not only take place upon failure of the brake booster 3 but also when the brake booster 3 has not yet been furnished with a sufficient rate of vacuum in a cold start. Besides, an overboost function can be realized, i.e. further pressure increase when an operating point P of the brake booster 3 is reached, and it is not possible to boost the input force by means of the brake booster 3. In the operating point P. additional pressure increase is possible only by an equally high rise of the input force in the prior art device. These functions can be achieved without additional measures or additional components.

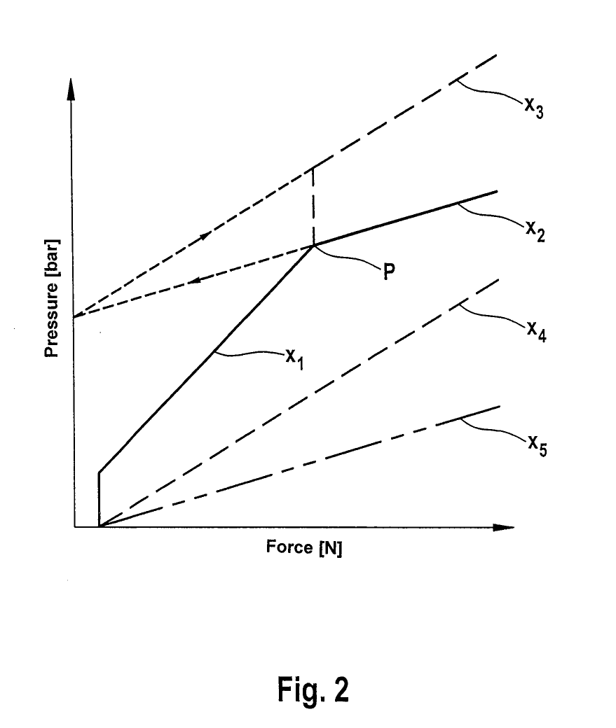

FIG. 2 shows a force-pressure diagram of the device according to FIG. 1 of the invention. In this arrangement, a curve x1 exhibits the characteristic curve of the master cylinder 2 until the operating point P. Until the operating point P, the characteristic curve x1 corresponds to a characteristic curve of a conventional master cylinder without change-over possibility at a sufficient vacuum of the brake booster. In excess of the operating point P, the characteristic curves will separate, and the master cylinder 2 of the device of the invention according to FIG. 1 shows an essential pressure increase compared to a conventional master cylinder, as can be taken from curves x2 and x3. Thus, curve x3 represents the overboost function of the described master cylinder 2.

Curves x4 and x5 show characteristic curves of a master cylinder 2 according to FIG. 1 and a conventional master cylinder in the event of vacuum failure (failed-boost). As can be seen in the characteristic curve X4, the change-over of the master cylinder 2 to the small effective surface A1 allows achieving a considerable pressure increase compared to the characteristic curve x5 of a conventional master cylinder.

FIGS. 3 and 4 show a schematic view of the change-over unit 51 of the device of the invention in the activated and non-activated positions.

The change-over unit 51 includes a first and a second housing portion 111, 112, and the vacuum box 55 is integrated in the first housing portion 111, and the valves 53, 54 of the valve assembly 52 are arranged on top of each other in the second housing portion 112. The vacuum box 55 includes a diaphragm 113 that is biased by means of one or more springs 114, 115, the diaphragm subdividing the first housing portion 111 into an atmospheric chamber 116 and a vacuum chamber 117.

As is apparent, the diaphragm 113 is compressed in a wall 118 of the first housing portion 111 and in a piston 119, and the springs 114, 115 abut on the piston 119 for preloading the diaphragm 113 or are arranged in a recess 120 of the piston 119. The vacuum chamber 117 includes an outlet 121, which connects by way of a pneumatic line 134 to the working chambers 83, 86 of the brake booster 3 (cf. FIG. 1).

The valve assembly 52 comprises a first actuating tappet 122 for the second valve 54, which is positively engaged with the piston 119 of the vacuum box 55, and a second actuating tappet 123 of the first valve 53, which is connected downstream in the flux of forces. Besides, a valve member 124 of the second valve 54 is attached to the first actuating tappet 122, and the second actuating tappet 123 along with a projection 135 forms the valve member of the first valve 53. Valve seats 125, 126 of the valves 53, 54 are arranged in corresponding recesses 127, 128 in the second housing portion 112. In the non-activated position, the second actuating tappet 123 is biased against the valve seat 126 by means of an additional spring 129 that bears against the projection 135.

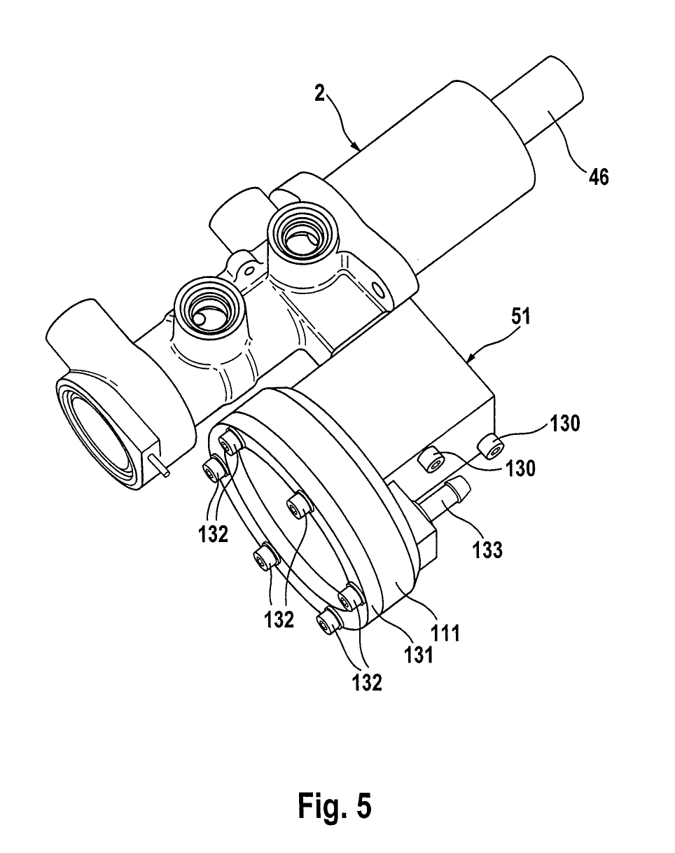

Furthermore, the first housing portion 111 can be closed by means of a cover 131, as can be seen in FIG. 5 in particular.

FIG. 3 shows that the valves 53, 54, in the activated position, establish a connection between the pressure chamber 10 and the annular chamber 47 by way of the pressure fluid lines 49, 50 and close a connection between the annular chamber 47 and the pressure fluid reservoir 56, since a sufficient rate of vacuum is available to the brake booster 3 and, thus, vacuum prevails in the vacuum chamber 117 of the vacuum box 55.

The difference in pressure between the atmospheric pressure 116 and the vacuum chamber 117 causes the piston 119 to displace in opposition to the spring force of the springs 114, 115 in the direction of the valve assembly 52, thus activating the valves 53, 54. The second valve 54 is closed in the activated position and shuts off the connection between the annular chamber 47 and the pressure fluid reservoir 56. The displacement of the first actuating tappet 122 also activates the first valve 53, opening the connection between annular chamber 47 and pressure chamber 10 because projection 135 lifts from valve seat 126.

FIG. 4 illustrates the valve assembly 52 in the non-activated position when atmosphere prevails in the vacuum chamber 117 due to lack in vacuum in the brake booster 3 or due to reaching of the operating point P. On account of equal pressures in atmospheric chamber 116 and vacuum chamber 117, the piston 119 is urged by the spring force of the springs 114, 115 into a direction opposite to the valve assembly 52. The valve member 124 of the second valve 54 also moves in this direction and, therefore, lifts from the valve seat 125, with the result that the connection between the annular chamber 47 and the pressure fluid reservoir 56 by way of the pressure fluid line 63 is opened. The first valve 53 is closed, since the second actuating tappet 123 is no longer pressed by the first actuating tappet 122 in opposition to the spring force of spring 129 to the top, as viewed in the drawing. This causes interruption of the connection between annular chamber 47 and pressure chamber 10, and the small effective surface Al of the master cylinder 2 is active.

FIG. 5 shows the master cylinder 2 and the change-over unit 51 of the device of the invention for the brake application 1, as described hereinabove, in a three-dimensional view. It is apparent that the change-over unit 51 can be arranged on the master cylinder 2. This obviates the need for separate connecting lines between the master cylinder 2 and the change-over unit 51, which must be mounted in the engine compartment and are susceptible to damages. The change-over unit 51 is attached to the housing 4 of the master cylinder 2 by means of screws 130, as can be seen.

Besides, it can be taken from FIG. 5 that the first housing portion 111 of the change-over unit 51 is closed by cover 131, which is secured to the wall 118 of the first housing portion 111 by means of screws 132. In the outlet 121 of the vacuum chamber 117 shown in FIGS. 3 and 4, a connection 133 is provided for fastening the pneumatic line 134, which connects the working chambers 83, 86 of the brake booster 3 and the vacuum chamber 117 of the vacuum box 55.

It is, however, also feasible within the limits of the invention to arrange and fasten the change-over unit 51 separately in the engine compartment irrespective of the master cylinder 2 of the device 1.

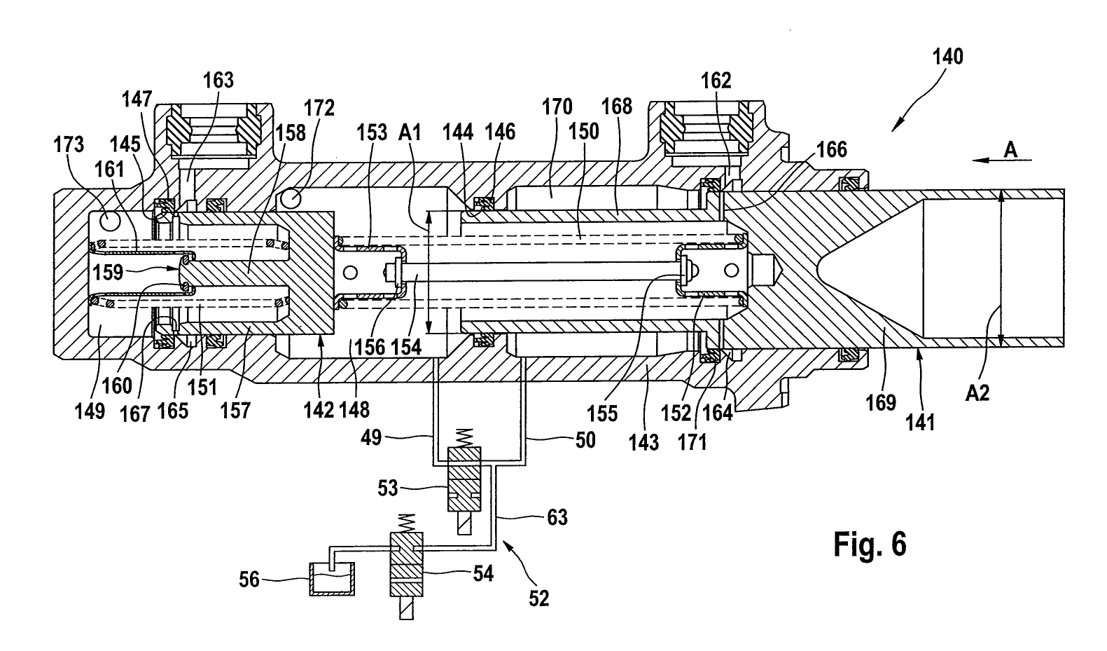

FIG. 6 shows a longitudinal cross-sectional view of a master cylinder of a second embodiment of a device for brake application according to the invention. The device for brake application 1 is different only with regard to the design of the master cylinder so that only the master cylinder will be described in the following.

As can be seen, the master cylinder 140 according to FIG. 6 is of the so-called plunger type with a first and a second bowl-shaped piston 141, 142 and with sealing cups 146, 147 being arranged stationarily in a housing 143 and abutting on pistons 141, 142 with a sealing lip 144, 145 for sealing a first and a second pressure chamber 148, 149. Fluid can flow over the sealing lips 144, 145 in the direction of the pressure chambers 148, 149 if a pressure gradient develops between the pressure fluid supply reservoir 12, shown in FIG. 1a, and wheel brakes 59, 60. For the non-activated operating condition, a pressure-compensating connection is further rendered possible between the two pressure chambers 148, 149 so that a general pressure balance exists also between the two brake circuits I, II for this non-activated operating condition.

Associated with each of the pistons 141, 142 is a resetting spring 150, 151, which is compressed in the event of piston displacement in the direction of activation A and is expanded for piston resetting purposes. As is apparent, the resetting spring 150 of the first piston 141 is captivated by means of two sleeves 152, 153 and a cylindrical pin 154, and the two sleeves 152, 153 and the pin 154 can be telescoped within limits by means of stops 155, 156 provided on the pin 154 and bring about an elastic bias of the resetting spring 150 in the non-activated condition.

The second piston 142 has a bowl-shaped wall 157, through which a centric peg 158 extends, which ends before its axial exit from the wall 157. This end 159 is provided with a stop 160 for a sleeve 161, whereby the sleeve 161 can be telescoped within limits in relation to the peg 158. More specifically, the sleeve 161 with resetting spring 151 is urged into the interior of the piston upon activation. As can be seen, the stop 160 is preferably an annular washer, which is riveted, in particular wobble-riveted, to the peg 158.

In the non-activated condition of the master cylinder 140 as shown, the pressure chambers 148, 149 communicate with the pressure fluid reservoir 12 by way of pressure fluid channels 162, 163 and supply chambers 164, 165 in the housing 143 as well as through transverse bores 166, 167 in the bowl-shaped pistons 141, 142.

The first piston 2 is displaced in the direction of activation A to activate the master cylinder 1. As this occurs, the movement of the first piston 141 is transmitted to the second piston 142 by way of the resetting spring 150. As soon as the transverse bores 166, 167 are disposed in the area of the sealing cup 146, 147, the so-called lost travel of the master cylinder 1 is covered, since pressure fluid cannot propagate from the supply chambers 164, 165 through the transverse bores 166, 167 into the pressure chambers 148, 149. The connection between the pressure chambers 148, 149 and the pressure fluid reservoir 12 is interrupted, and pressure is built up in the pressure chambers 148, 149, which propagates to the wheel brakes 59, 60 (not shown) by way of outlets 172, 173.

The first piston 141 has a stepped design and includes a first piston portion 168 facing the first pressure chamber 148 and having a first, small hydraulically active effective surface A1 that faces the first pressure chamber 148, and a second, large piston portion 169 with a second, large, hydraulically active effective surface A2. The second piston portion 169 serves to connect the first piston 141 to a push rod 70 of the brake booster 3 according to FIG. 1.

Along with the housing 143, the first and the second piston portion 168, 169 delimit an annular chamber 170, which is sealed by means of another sealing cup 171 in relation to the supply chamber 164. Fluid can flow over the sealing cup 171 in the direction of the annular chamber 170.

Similar to the first embodiment according to FIGS. 1 to 4, the first pressure chamber 148 and the annular chamber 170 are connected to the change-over unit 51 by way of the first and the second pressure fluid line 49, 50, while the valves 53, 54 of the valve assembly 52 are represented only as wiring diagrams. FIGS. 3 and 4 depict the change-over unit 51 that has been explained in more detail so that a repeated description is unnecessary.

As has already been described in detail with respect to the first embodiment, the annular chamber 170 is connectable either to the first pressure chamber 148 or to the separate pressure fluid reservoir 56 by means of the valve assembly 52, which can be operated depending on the pressure of the working chambers 83, 86 of the brake booster 3. In this arrangement, the first valve 53 in its activated position connects the pressure chamber 148 to the annular chamber 170, while the second valve 54 in its activated position shuts off the connection between the annular chamber 170 and the pressure fluid reservoir 56.

The change-over unit 51 permits a change-over of the master cylinder 140 from the large effective surface A2 to the small effective surface A1 when, in the event of failure of the brake booster 3, no vacuum or insufficient vacuum is available in the working chambers 83, 86 (cold start), or when the operating point P of the brake booster 3 is reached, respectively, and further pressure increase is required (overboost function).

The force-pressure diagram illustrated in FIG. 2 equally applies to the master cylinder 140 of the plunger-type construction.

1-13. (canceled)

14. A device for the brake application of a motor vehicle comprising:
a master cylinder with a housing and a first and a second piston displaceably arranged in the housing, said piston delimiting together with the housing in each case a first and a second pressure chamber being connectable to an unpressurized pressure fluid reservoir by way of a pressure fluid channel and to wheel brakes by way of an outlet, and
a pneumatic brake booster with a booster housing, whose interior is subdivided by at least one movable wall into at least one vacuum chamber and at least one working chamber, with the movable wall, depending on a pedal force effective on a piston rod, transmitting a force onto a push rod that can be connected to the first piston of the master cylinder, when the movable wall is under the effect of a difference in pressure that prevails between the two chambers, with one of the pistons of the master cylinder having a stepped design with two differently sized hydraulically active effective surfaces and change-over of the effective surfaces takes place by means of a valve assembly upon failure of the brake booster,
wherein an annular chamber, which is delimited by the stepped piston and the housing, is connectable by means of the valve assembly either to the pressure chamber associated with the stepped piston or to a pressure fluid reservoir,
the valve assembly comprises a first and a second valve, which are switchable depending on the pressure of the working chamber of the brake booster, and the first valve in its activated position connects the pressure chamber to the annular chamber, and the second valve in its activated position closes the connection between the annular chamber and the pressure fluid reservoir.

15. The device as claimed in claim 14,
wherein the first valve is connected through a first pressure fluid line to the pressure chamber and through a second pressure fluid line to the annular chamber, and in that a third pressure fluid line is provided, by way of which the annular chamber is connectable to the pressure fluid reservoir, with the second valve being arranged in the third pressure fluid line and the said line branching from the second pressure fluid line.

16. The device as claimed in claim 15,
wherein a vacuum box is used to drive the valves of the valve assembly.

17. The device as claimed in claim 16,
wherein the valve assembly and the vacuum box are integrated in a change-over unit.

18. The device as claimed in claim 17,
wherein the change-over unit is configured to be secured to the master cylinder.

19. The device as claimed in claim 17,
wherein the change-over unit is configured to be fastened as a separate component in the engine compartment.

20. The device as claimed in claim 18,
wherein the valves in the change-over unit are positioned on top of one another.

21. The device as claimed in claim 20,
wherein the change-over unit includes a first and a second housing portion, with the vacuum box being integrated in the first housing portion and the valves of the valve assembly being arranged in the second housing portion, and in that the vacuum box includes a spring-preloaded diaphragm subdividing the first housing portion into an atmospheric chamber and a vacuum chamber.

22. The device as claimed in claim 21,
wherein the diaphragm is compressed in a wall of the first housing portion and in a piston, in that the valve assembly includes a first actuating tappet for the second valve, being positively engaged with the piston of the vacuum box, and a second actuating tappet of the first valve that is connected downstream in the flux of forces, and a valve member of the second valve is attached to the first actuating tappet, and a projection of the second actuating tappet forms the valve member of the first valve, and in that valve seats of the valves are arranged in recesses of the second housing portion.

23. The device as claimed in claim 14,
wherein the master cylinder is a central-valve tandem master cylinder.

24. The device as claimed in claim 14,
wherein the master cylinder is a plunger-type construction.

25. A method for changing the effective surfaces of a device for brake application as claimed in claim 14,
wherein the effective surfaces are changed over depending on the pressure of the working chamber of the brake booster.

26. The method as claimed in claim 25,
wherein the valve assembly is switched by means of a vacuum box.
